(19) United States
(12) Patent Application Publication
(10) Pub. No.: US 2008/0158131 A1
(43) Pub. Date: Jul. 3, 2008

(54) LCD data drivers

(76) Inventors: Keun-Woo Park, Seoul (KR); Pil-Mo Choi, Seoul (KR); Ho-Suk Maeng, Seoul (KR); Kook-Chul Moon, Yongin-si (KR); Chul-Ho Kim, Gyeonggi-do (KR); Sang-Hoon Lee, Seoul (KR); Kyung-Hoon Kim, Uiwang-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/982,663

(22) Filed: Nov. 2, 2007

(30) Foreign Application Priority Data
Nov. 24, 2006 (KR) 10-2006-0116986

(51) Int. Cl. G09G 3/36

(52) U.S. Cl. 345/98

(57) ABSTRACT

A liquid crystal display (LCD) includes associated pairs of amplifiers used in an output buffer of a data driver to implement dot inversion driving of the LCD. The data driver includes a first amplifier having an output terminal connected to a first data line and outputting a positive polarity voltage, a second amplifier having an output terminal connected to a second data line and outputting a negative polarity voltage, and a switching unit connected between the output terminals of the two amplifiers and the two data lines and operative in response to a switching signal to interchange the amplifier output signals respectively applied to the data lines.

### RELATED APPLICATIONS

This application claims priority of Korean Patent Application No. 2006-0116986, filed Nov. 24, 2006, the entire disclosure of which is incorporated herein by reference.

### BACKGROUND

The present disclosure relates to liquid crystal displays (LCDs) in general, and in particular, to LCDs that configure amplifiers used in an output buffer of a data driver thereof in associated pairs to carry out dot inversion driving thereof. Generally speaking, LCDs are a type of display device that display an image by adjusting the light transmissivity of a layer of a liquid crystal material disposed between a thin film transistor (TFT) substrate and a color filter substrate that have respective electrodes arranged opposite to each other. The light transmissivity of the liquid crystal layer is controlled by an electric field generated by a voltage applied to the electrodes.

LCDs typically include a display panel that includes a plurality of pixels connected to a plurality of orthogonally intersecting gate lines and data lines, a data driver for supplying image data signals to the data lines, a gate driver for supplying gate driving signals to the gate lines, a timing controller for controlling the gate driver and data driver, and a power supply for supplying driving voltages to the liquid crystal panel.

LCDs are driven by an alternating current (AC) signal using a method that applies electric fields having opposite polarities to adjacent pixels to prevent the liquid crystal material from becoming polarized in a specific direction, thereby improving display performance.

The various methods of applying AC signals to the pixels include a “dot inversion” method that drives the liquid crystal display panel by inverting the polarities of voltages applied to adjacent dots, a “line inversion” method that drives the panel by inverting the polarities of voltages applied to adjacent gate lines, a “column inversion” method that drives the panel by inverting the polarities of voltages applied to adjacent data lines, a “frame inversion” method that drives the liquid crystal panel by inverting the polarities of voltages applied to all the pixels once per frame period, and the like.

In order to drive a conventional LCD with the dot inversion method, the data driver includes a pair of operational amplifiers (op-amps) for outputting a positive polarity voltage and a negative polarity voltage provided to each of data lines. In operation, when the positive op-amp outputs a positive polarity voltage to an nth data line, the negative op-amp is idle. Conversely, when the negative op-amp outputs a negative polarity voltage to the nth data line, the positive op-amp is idle. However, this creates a problem when conventional LCDs are driven by the dot inversion method in that the power consumption of the display is increased, since the op-amps consume static current even when in the idle state.

Additionally, portable digital devices, such as digital still cameras (DSCs), digital multimedia broadcasting (DMB) terminals, and the like, which are in widespread use, require a thin, compact design that minimizes the size of the data driver in order to mount a data driver integrated circuit (“IC”) on only one side of the LCD. Accordingly, the idle-state op-amps are a factor restricting the provision of thin, compact designs for portable devices equipped with LCD panels.

### BRIEF SUMMARY

In accordance with the exemplary embodiments disclosed herein, LCDs are provided in which amplifiers outputting positive and negative polarity voltage are configured in pairs to effect a dot inversion driving thereof, thereby reducing the number of amplifiers.

In one exemplary embodiment, a novel LCD data driver includes first and second amplifiers, each having an output terminal respectively outputting positive and negative polarity voltages to a respective one of a pair of associated data lines, and a switching unit disposed between the amplifiers and the data lines and operable to interchangeably connect the respective output terminals of the amplifiers to respective ones of the data lines in response to a switching signal.

The switching unit includes at least one PNP transistor and at least one NPN transistor driven in response to the switching signal, and uses a polarity inversion signal generated from a timing controller as the switching signal.

In another exemplary embodiment, an LCD data driver comprises an output buffer unit that include a plurality of amplifiers respectively corresponding to data lines, wherein the amplifiers are arranged in associated pairs, each amplifier pair including a first amplifier outputting a positive polarity voltage and a second amplifier outputting a negative polarity voltage, and wherein the respective outputs of the first and second amplifiers of each amplifier pair are interchanged with each other in response to a switching signal.

The output buffer unit further comprises a plurality of switching units for switching the outputs of the first and second amplifiers of each amplifier pair between each other in response to the switching signal.

In another exemplary embodiment, an LCD comprises: a liquid crystal panel that includes a plurality of gate lines to which respective gate driving signals are applied; a plurality of data lines to which respective voltages corresponding to display data are applied; a plurality of pixels presenting the display data in response to the voltages; a data driver generating the voltages based on gamma voltages and applying the voltages to the data lines in response to a switching signal; a gate driver applying the gate driving signal to the gate lines; and, a timing controller generating a data control signal that includes the switching signal and a gate control signal that includes the gate driving signal, wherein the data driver comprises a plurality of amplifiers, each corresponding to a respective one of the data lines, the amplifiers being paired with each other, each pair of amplifiers including a first amplifier outputting a positive polarity voltage and a second amplifier outputting a negative polarity voltage, and wherein outputs of the first and second amplifiers are interchanged each other in response to the switching signal.

The data control signal further comprises a data start signal, a data synchronization signal, a load signal, and a polarity inversion signal, and the data driver further comprises: a shift register unit generating a sampling signal in response to the data start signal and the data synchronization signal; an input register unit sequentially storing display data corresponding to a portion of the pixels of one gate line in response to the sampling signal; a storage register unit simultaneously receiving and storing the display data of the portion of the pixels of the one gate line in response to the load signal; a digital/analog converter generating the analog voltage corresponding to each value of the display data of the portion of one gate line using the gamma voltage; and, an output buffer unit including the plural pairs of the amplifiers outputting the analog voltages in response to the switching signal.

The data lines of the liquid crystal display panel are alternately connected to pixels positioned on the left and right sides of the data line, based on the gate line to which the pixels are connected.

The gate control signal further comprises a gate start signal.

A better understanding of the above and many other features and advantages of the LCDs and data drivers of the present invention may be obtained from a consideration of the detailed description below of some exemplary embodiments thereof, particularly when such consideration is made in conjunction with the appended drawings, wherein like reference numerals are used to identify like elements illustrated in one or more of the figures thereof.

### BRIEF DESCRIPTION OF THE DRAWINGS

FIG. 1 is a functional block and schematic signal flow diagram of an exemplary embodiment of an LCD in accordance with the present invention;

FIG. 2 is a functional block and schematic signal flow diagram of an exemplary embodiment of a data driver of the LCD of FIG. 1;

FIG. 3 is a functional block diagram of an exemplary output buffer unit of the exemplary data driver of FIG. 2, shown used in conjunction with an exemplary LCD panel;

FIG. 4 is a schematic circuit diagram of an exemplary switching unit of the output buffer unit of FIG. 3;

FIGS. 5A and 5B are schematic circuit diagrams illustrating the operation of the switching unit of FIG. 4; and,

FIG. 6 is a partial schematic plan view of another exemplary embodiment of an LCD panel in accordance with the present invention, showing the interconnections between data lines and pixels thereof.

### DETAILED DESCRIPTION

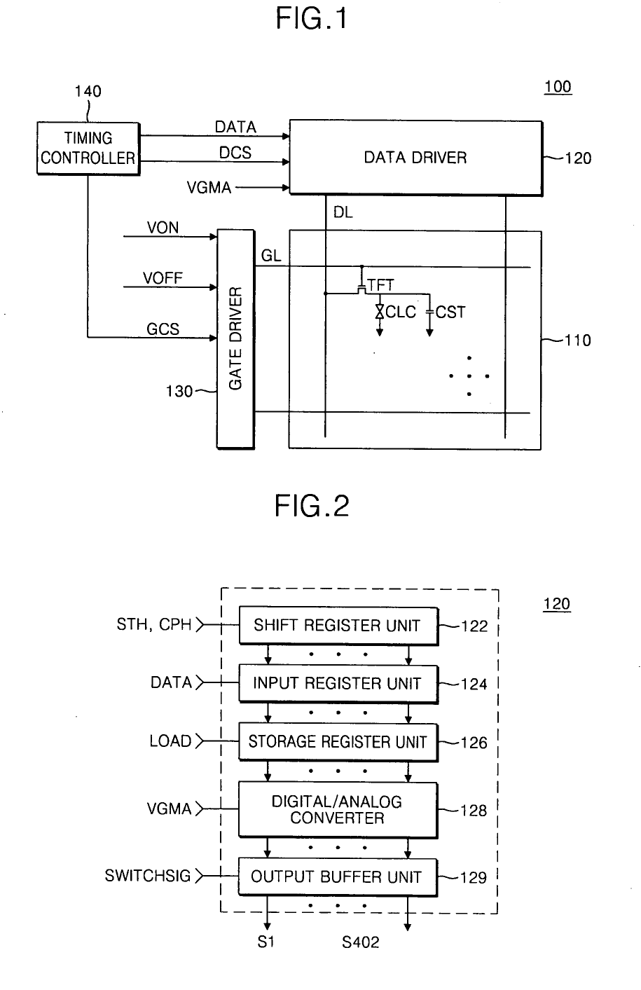

FIG. 1 is a functional block and schematic signal flow diagram of an exemplary embodiment of an LCD 100 in accordance with the present invention. As depicted in the figure, the LCD 100 includes a liquid crystal panel 110, a data driver 120, a gate driver 130, and a timing controller 140.

The liquid crystal panel 110 includes a color filter substrate having a plurality of color filters and a common electrode, a thin film transistor (TFT) substrate having a plurality of TFTs thereon, and a layer of a liquid crystal material sealed between the color filter substrate and the TFT substrate.

The TFT substrate further includes a plurality of pixels and associated pixel capacitors CLC for presenting display data DATA at respective intersections of gate lines GL and data lines DL, TFTs for supplying a voltage corresponding to the display data DATA to the respective pixel capacitors CLC in response to a gate driving signal, and storage capacitors CST for maintaining the voltage corresponding to the display data DATA applied to each pixel capacitor CLC for one frame period.

Each TFT includes a gate connected to the gate line GL, a source connected to the data line DL, and a drain connected to the pixel electrode of the pixel capacitor CLC. The molecules of the liquid crystal layer are oriented in response to an electric field formed between the common electrode of the color filter substrate and the respective pixel electrodes of the TFT substrate so as to vary the light passing through respective ones of the pixels in accordance with the display data DATA respectively applied thereto.

The data driver 120 generates analog voltages corresponding to the display data DATA using a gamma voltage VGMA reference and supplies the analog voltages to respective ones of the TFTs, rows of which are sequentially driven by respective gate driving signals applied thereto, thereby presenting the display data DATA in successive rows, beginning at the top of the panel and ending at the bottom thereof, so as to display one frame of image data.

The data driver 120 receives a data control signal DCS and the display data DATA from the timing controller 140, and the gamma voltage VGMA from a gamma voltage generator (not illustrated). The data control signal DCS includes a data start pulse STH, a data synchronization clock CPH, a load signal LOAD, and a polarity inversion signal POL.

The gate driver 130 delivers the gate driving signals to selected ones of the plural gate lines GL in sequential order so as to turn on the TFTs respectively connected to the gate lines selected. For this purpose, the gate driver 120 receives a gate control signal GCS from the timing controller 140, and a gate-on voltage VON and a gate-off voltage VOFF used as the gate driving signal from a power supply (not illustrated). The gate control signal GCS includes a gate start pulse STV and a gate synchronization clock CPV.

The gate driver 130 may be integrally formed of an amorphous silicon gate (ASG) in a non-display region of the TFT substrate when the TFT substrate is being fabricated.

The timing controller 140 is operable to convert the externally input display data DATA into display data DATA that the data driver 120 can process and to supply the same to the data driver 120, and also to apply the control signals GCS and DCS to the data driver 120 and the gate driver 130 respectively required for their operation.

FIG. 2 is a functional block and schematic signal flow diagram of the data driver 120 of the LCD 100 of FIG. 1. As illustrated in the figure, the exemplary preferred data driver 120 includes a shift register unit 122, an input register unit 124, a storage register unit 126, a digital/analog converter 128, and an output buffer unit 129.

The shift register unit 122 receives the data start signal STH and the data synchronization clock CPH to generate a sampling signal, and inputs the sampling signal to the input register unit 124. In more detail, the shift register unit 122 generates n sampling signals by shifting the data start signal STH every cycle of the data synchronization clock CPH. Accordingly, the shift register unit 122 includes n shift registers. Here, ‘n’ corresponds to the number of data lines DL.

The input register unit 124 sequentially stores the display data DATA in response to the sampling signal sequentially input from the shift register unit 122. That is, the input register unit 124 stores display data DATA corresponding to the pixels connected to one gate line GL in response to the sampling signals. For this purpose, the input register unit 124 includes a data input latch for latching and storing the n data corresponding to the respective pixels of the one gate line.

When the load signal LOAD is input, the storage register unit 126 simultaneously receives the display data DATA of the pixels of one gate line stored in the input register unit 124 and stores the same. For this purpose, the storage register unit 126 includes the same number of data storage latches as the number of data input latches in the input register unit 124.

Using the gamma voltage VGMA, the digital/analog converter 128 generates an analog voltage corresponding to the display data value DATA and outputs the same to the output buffer unit 129.

The output buffer unit 129 includes a plurality of amplifiers that amplify the respective analog voltages supplied from the digital/analog converter 128 and applies them to the corresponding data lines S1 to S402 in response to a switching signal SWITCHSIG. Although a total of 402 data lines are depicted in the particular exemplary embodiment illustrated in FIG. 2, it should be understood that the number of the data lines is not limited thereto. It is desirable that the number of the amplifiers be the same as the number data lines S1 to S402.

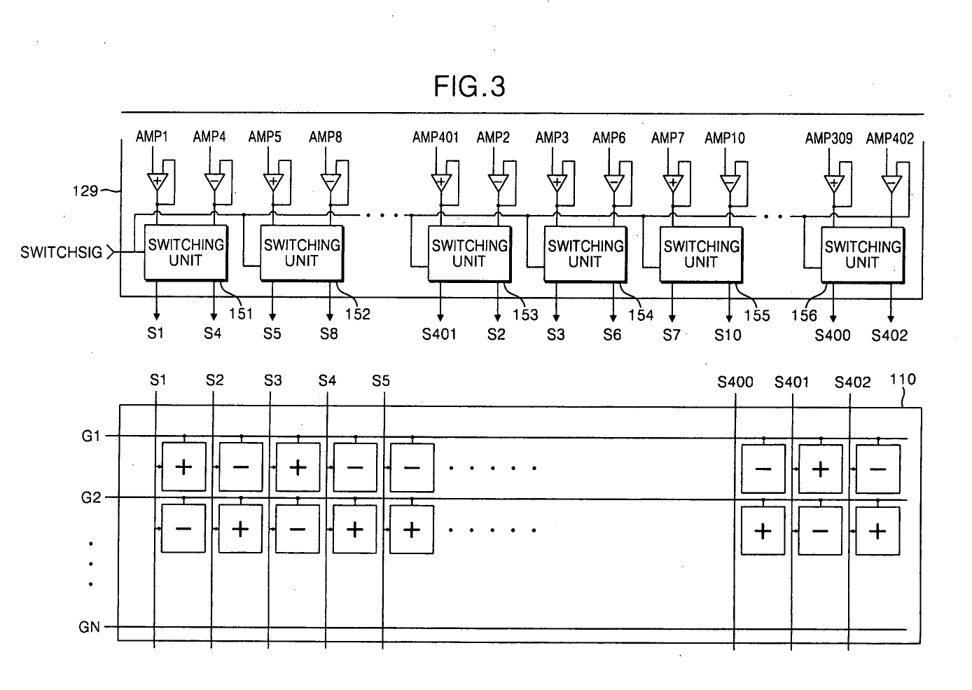

In the particular embodiment illustrated, the output buffer unit 129 includes a plurality of pairs of amplifiers, each pair outputting a positive polarity voltage and a negative polarity voltage, to effect a dot inversion driving of the LCD, thus reducing the number of the amplifiers needed, as compared to conventional LCDs. An output buffer unit 129 having the above structure is described in more detail below with reference to FIG. 3.

FIG. 3 is a functional block diagram of an exemplary embodiment of the output buffer unit 129 of the exemplary data driver 120 of FIG. 2, shown in use with an exemplary LCD panel 110.

As illustrated in FIG. 3, the output buffer unit 129 includes a plurality of amplifiers AMP1 to AMP402, each corresponding to a respective one of the data lines S1 to S402, and the liquid crystal panel 110 includes a plurality of pixels, formed at intersections of the gate lines G1 to GN and the data lines S1 to S402, to which respective polarity voltages corresponding to the display data DATA are applied.

The plural amplifiers AMP1 to AMP402 are arranged such that each of the odd-numbered positive amplifiers AMP1, AMP3 . . . AMP401 is paired with a respective one of the even-numbered negative amplifiers AMP2, AMP4 . . . AMP402.

The output buffer unit 129 further includes a plurality of switching units 151 to 156, each of which has a pair of inputs respectively coupled to the outputs of a corresponding pair of the positive and negative amplifiers, and a pair of outputs, and each of which is operable to respectively output the inputs from the corresponding amplifier pair in the same order, or alternatively, to interchange and output the inputs from the corresponding amplifier in the reverse order in response to the input of a switching signal SWITCHSIG.

It is preferable that the pairs of odd-numbered positive and even-numbered negative amplifiers not be arranged in a sequential order. Thus, in the particular exemplary embodiment of FIG. 3, the arrangement of the amplifier pairs of the output buffer unit 129 is as illustrated in the following Table 1.

TABLE 1

| +Output Amp | AMP1 | AMP5 | . . . | AMP401 | AMP3 | AMP7 | . . . | AMP309 |
|---|---|---|---|---|---|---|---|---|
| −Output Amp | AMP4 | AMP8 | . . . | AMP2 | AMP6 | AMP10 | . . . | AMP402 |
| Switching Unit | 151 | 152 | . . . | 153 | 154 | 155 | . . . | 156 |

Referring to Table 1, the odd-numbered positive amplifiers are paired with even-numbered negative amplifiers that have a number equal to the number of the odd amplifier, plus 3, and additionally, the amplifiers are arranged such that consecutively numbered odd-numbered amplifiers are not disposed adjacent to each other. In such an arrangement, for example, the second negative amplifier AMP2 is paired with the last odd-numbered positive amplifier AMP401, thereby minimizing any undesirable influence that the switching operations of the respective switching units have on the adjacent data lines.

The switching units 151 and 156 are operable to interchange, or switch the respective outputs of the positive and negative amplifiers of each amplifier pair with respect to each other. For example, the switching unit 151 switches the respective outputs of the positive amplifier AMP1 and the negative amplifier AMP4 between the two data lines S1 and S4.

Accordingly, when the gate driving signal is sequentially supplied to the gate lines G1 to GN, the pixels connected to the gate lines G1 to GN present the display data in accordance with the dot inversion method in response to the polarity of the voltages applied to the data lines S1 to S402.

Additionally, although the exemplary output buffer unit 129 of FIG. 3 is illustrated as including the plural amplifiers AMP1 to AMP402 respectively outputting the polarity voltages corresponding to the plural data lines S1 to S402, it should be understood that the present invention is not limited thereto. For example, each pair of the data lines may correspond to only a single pair of positive and negative amplifiers.

In the latter case, a single pair of positive and negative amplifiers supplies the positive and negative polarity voltages to each of the plural data line pairs through a multiplexing device (not illustrated). For example, where a pair of positive and negative amplifiers supplies the positive and negative polarity voltages to six pairs of data lines S1 and S4; S5 and S12; S9 and S12; S13 and S16; S17 and S20; and S21 and S24 through a multiplexing arrangement, the total number of the total amplifiers can be decreased to ⅙ of the number of amplifiers of the embodiment of FIG. 3.

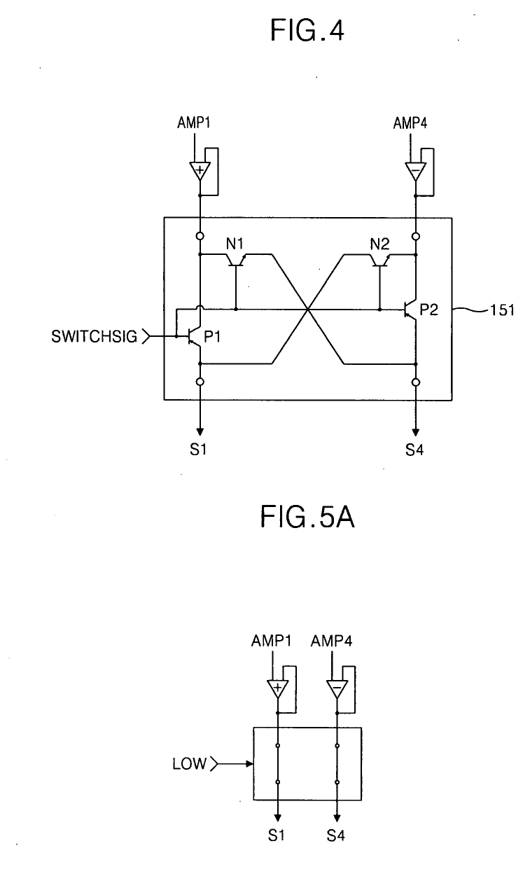

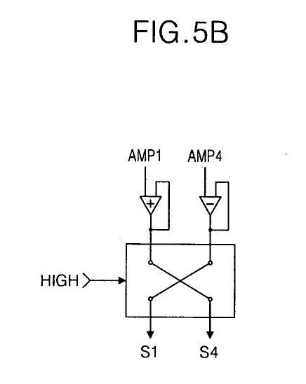

The structure and operation of the switching unit for switching the outputs of each pair of positive and negative amplifiers is described in more detail below with reference to FIGS. 4, 5A, and 5B.

FIG. 4 is a schematic circuit diagram of an exemplary switching unit 151 of the output buffer unit 129 of FIG. 3. As illustrated in the figure, the switching unit 151 of the output buffer includes a pair of PNP transistors P1 and P2 and a pair of NPN transistors N1 and N2 that operate as a switch in response to the switching signal SWITCHSIG.

The PNP transistors P1 and P2 switch the positive amplifier AMP1 to the data line S1 and the negative amplifier AMP4 to the data line S4. The NPN transistors N1 and N2 switch the positive amplifier AMP1 to the data line S4 and the negative amplifier AMP4 to the data line S1.

For example, when a low level switching signal SWITCHSIG is applied, the PNP transistors P1 and P2 are turned on and the NPN transistors N1 and N2 are turned off, such that the positive amplifier AMP1 outputs a positive polarity voltage to the data line S1 and the negative amplifier AMP4 outputs a negative polarity voltage to the data line S4. FIG. 5A is a schematic circuit diagram illustrating the state of the switching unit 151 when a low level switching signal SWITCHSIG is applied.

Conversely, when a high level switching signal SWITCHSIG is applied, the PNP transistors P1 and P2 are turned off and the NPN transistors N1 and N2 are turned on, such that the positive amplifier AMP1 outputs a positive polarity voltage to the data line S4 and the negative amplifier AMP4 outputs a negative polarity voltage to the data line S1. FIG. 5B is a schematic circuit diagram illustrating the state of the switching unit 151 when a high level switching signal SWITCHSIG is applied.

The switching signal SWITCHSIG may be a polarity inversion signal POL generated from the timing controller or a gate driving signal sequentially applied to the gate lines G1 to GN.

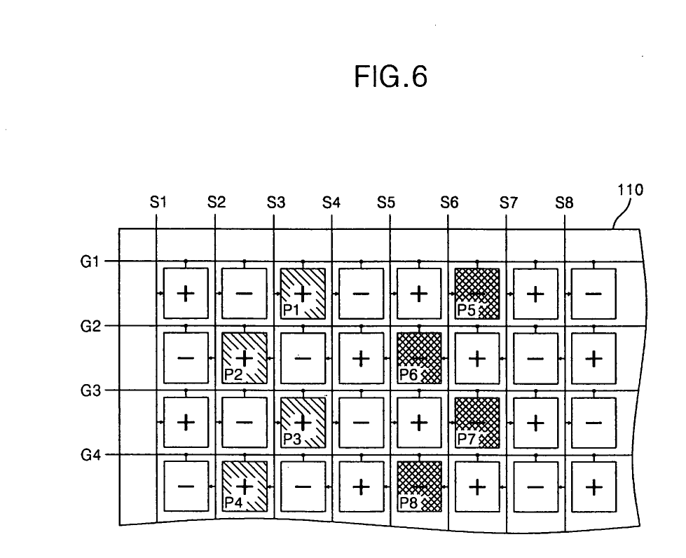

FIG. 6 is a partial schematic plan view of another exemplary embodiment of a liquid crystal display panel 110 in accordance with the present invention, showing the interconnections between the data lines and pixels thereof. In the exemplary LCD panel 110 illustrated, each of the data lines S1 to S8 is alternately connected to pixels positioned on the left and right sides of the data line, depending on the gate line to which the pixels are attached.

For example, the data line S3 corresponding to the positive, amplifier AMP3 is connected to pixels P1 and P3 positioned on the right side of the data line S3 on odd-numbered gate lines, and to pixels P2 and P4 positioned on the left side of the data line S3 on even-numbered gate lines.

Moreover, the data line S6 corresponding to the negative amplifier AMP6 paired with the positive amplifier AMP3 is connected to pixels P5 and P7 positioned on the right side of the data line S6 in odd-numbered gate lines, and to pixels P6 and P8 positioned on the left side of the data line S6 in even-numbered gate lines.

Accordingly, when the output buffer has a structure in which the positive and negative amplifiers are arranged in pairs, as described with reference to FIG. 3, the liquid crystal panel 110 is driven in the dot inversion method by the switching units 151 to 156 operating in response to the switching signal SWITCHSIG. In this instance, it is preferable that the switching signal SWITCHSIG be a gate start signal STV generated on a per-frame basis.

As described above, the LCDs of the present invention having a structure in which each of the amplifiers outputting a positive polarity voltage and each of the amplifiers outputting a negative polarity voltage are configured in pairs to implement dot inversion driving provide the distinct advantages of reducing the size of the driver IC by reducing the number of the amplifiers provided therein, and further, reducing the power consumption thereof.

Although several exemplary embodiments of the present invention have been illustrated herein and described in detail above, it should be clearly understood that many variations and/or modifications of the basic inventive concepts taught herein that may occur to those skilled in the present art will still fall within the spirit and scope of the present invention, as defined by the claims appended hereafter and their functional equivalents.

What is claimed is:

1. A data driver, comprising:
first and second amplifiers, each having an output terminal respectively outputting positive and negative polarity voltages to a respective one of a pair of associated data lines; and,
a switching unit disposed between the amplifiers and the data lines and operable to interchangeably connect the respective output terminals of the amplifiers to respective ones of the data lines in response to a switching signal.

2. The data driver of claim 1, wherein the switching unit includes at least one PNP transistor and at least one NPN transistor driven in response to the switching signal.

3. The data driver of claim 2, wherein the switching unit uses a polarity inversion signal generated from a timing controller as the switching signal.

4. A data driver, comprising an output buffer unit having a plurality of amplifiers respectively corresponding to a plurality data lines, the amplifiers being arranged in associated pairs, each amplifier pair including a first amplifier outputting a positive polarity voltage and a second amplifier outputting a negative polarity voltage, and wherein the outputs of the first and second amplifiers are interchangeable with each other in response to a switching signal.

5. The data driver of claim 4, wherein the output buffer unit further comprises a switching unit for interchanging the outputs of the first and second amplifiers with each other in response to the switching signal.

6. The data driver of claim 5, wherein the switching unit comprises at least one PNP transistor and at least one NPN transistor driven in response to the switching signal.

7. The data driver of claim 6, wherein the switching unit uses a polarity inversion signal generated from a time controller as the switching signal.

8. The data driver of claim 6, wherein the switching unit uses a gate driving signal sequentially applied to gate lines as the switching signal.

9. A liquid crystal display (LCD), comprising:
a liquid crystal display panel, including a plurality of gate lines to which gate driving signals are respectively applied, a plurality of data lines to which voltages corresponding to display data are respectively applied, and a plurality of pixels presenting the display data in response to the applied voltages;
a data driver generating the voltages based on a gamma voltage and applying the voltages to the data lines in response to a switching signal;
a gate driver applying the gate driving signal to the gate lines; and,
a timing controller generating a data control signal that includes the switching signal and a gate control signal that includes the gate driving signal,
wherein the data driver comprises a plurality of amplifiers corresponding to respective ones of the data lines, the amplifiers being arranged in associated pairs, each amplifier pair including a first amplifier outputting a positive polarity voltage and a second amplifier outputting a negative polarity voltage, and wherein respective outputs of the first and second amplifiers are interchangeable with each other in response to the switching signal.

10. The LCD of claim 9, wherein the data control signal further comprises a data start signal, a data synchronization signal, a load signal, and a polarity inversion signal.

11. The LCD of claim 10, wherein the data driver further comprises:
a shift register unit generating a sampling signal in response to the data start signal and the data synchronization signal;
an input register unit sequentially storing display data corresponding to a portion of the pixels connected to one gate line in response to the sampling signal;
a storage register unit simultaneously receiving and storing the display data of the portion of the pixels connected to one gate line in response to the load signal;
a digital/analog converter generating the analog voltage corresponding to each value of the display data of the portion of the pixels connected to the one gate line using the gamma voltage; and,
an output buffer unit including the plural pairs of the amplifiers outputting the analog voltages in response to the switching signal.

12. The LCD of claim 11, wherein the output buffer unit further includes a plurality of switching units for interchanging the outputs of respective pairs of amplifiers with each other.

13. The LCD of claim 12, wherein the switching unit comprises at least one PNP transistor and at least one NPN transistor driven in response to the switching signal.

14. The LCD of claim 13, wherein the switching unit uses the polarity inversion signal as the switching signal.

15. The LCD of claim 13, wherein the switching unit uses the gate driving signal sequentially applied to the gate lines as the switching signal.

16. The LCD of claim 9, wherein the data lines of the liquid crystal panel are alternately connected to pixels positioned at left and right sides of the data line based on the gate line to which the pixels are connected.

17. The LCD of claim 16, wherein the data control signal further comprises a data start signal, a data synchronization signal, a load signal, and a polarity inversion signal, and wherein the gate control signal further comprises a gate start signal.

18. The LCD of claim 17, wherein the data driver comprises:
a shift register unit generating a sampling signal in response to the data start signal and the data synchronization signal;
an input register unit sequentially storing display data corresponding to a portion of one gate line in response to the sampling signal;
a storage register unit simultaneously receiving storing the display data of the portion of one gate line in response to the load signal;
a digital/analog converter generating the analog voltage corresponding to each value of the display data of the portion of one gate line in response to the load signal; and,
an output buffer unit including the plural pairs of the amplifiers outputting the analog voltages in response to the switching signal.

19. The LCD of claim 18, wherein the output buffer unit comprises switching units for interchangeably switching the outputs of the respective pairs of amplifiers with each other.

20. The liquid crystal display of claim 19, wherein each switching unit comprises at least one PNP transistor and at least one NPN transistor driven in response to the switching signal.
